(19) United States
(12) Patent Application Publication
(10) Pub. No.: US 2008/0086376 A1
(43) Pub. Date: Apr. 10, 2008

(54) INCREMENTAL PROMOTION FOR ELECTRONIC COMMERCE

(75) Inventor: Richard ROTHKOPF, Chicago, IL (US)

Correspondence Address: ROTHWELL, FIGG, ERNST & MANBECK, P.C., 1425 K STREET, N.W., SUITE 800, WASHINGTON, DC, 20005, US

(73) Assignee: WEBLOYALTY.COM, Norwalk, CT (US)

(21) Appl. No.: 11/865,492

(22) Filed: Oct. 1, 2007

Related U.S. Application Data
(63) Continuation of application No. 09/520,798, filed on Mar. 8, 2000, now abandoned.

(51) Int. Cl. G06Q 30/00; G06F 17/30; G06F 17/40

(52) U.S. Cl. 705/14

(57) ABSTRACT

A method and apparatus for offering a promotional award to a visitor to an electronic commerce site. The electronic commerce apparatus comprises a connection to a distributed communication network, at least one promotional awards storage area for a visitor, including a customer identifier storage and an award amount storage, and an awards rule storage, wherein the visitor is granted a promotional award upon visiting the electronic commerce site, with the promotional award amount being controlled by an awards rule contained in the awards rule storage. The method comprises the steps of detecting a site visit by a visitor, granting a promotional award to the visitor, and adding the promotional award to a pre-existing promotional award, if the site visit is not a first site visit by the visitor, wherein the visitor is motivated to make multiple site visits and a purchase as a result of the promotional award.

### BACKGROUND OF THE INVENTION

1. Field of the Invention

The present invention relates generally to the promotion of commercial transactions over a distributed communication network, and more particularly to a promotional award given to a visitor of an electronic commerce site.

2. Description of the Background Art

Electronic commerce is the transaction of commerce through an electronic medium, such as a distributed communication network. A common such network is the Internet, but may also include other networks including common digital and computer networks such as a local area network (LAN), wide-area network (WAN), or a virtual private network (VPN), for example. As the most widespread and popular distributed communication network, the Internet will be used in all further discussion.

The Internet has become very popular for electronic commerce, with merchants electronically advertising and selling a wide variety of goods and services. The Internet has also proven to be a valuable tool for advertising and for building name or brand recognition, and therefore for establishing or increasing market share.

Current statistics show that electronic commerce is growing at a very rapid pace, and appears to be on track to achieve a significant share of the total market in goods and services. Current estimates are that over 70 million Americans have Internet access, with this number projected to soon reach about 150 million. Correspondingly, on-line sales transactions reached $5 billion in 1998 and are expected to reach $17.5 billion by the year 2001. Meanwhile, Internet advertising revenues reached $1.92 billion in 1998.

Several reasons exist for the popularity and growth of electronic commerce. From the customer's point of view, electronic commerce offers the benefits of convenience, around-the-clock availability, quick delivery using overnight or other shipping methods, a much greater degree of anonymity, no need to fight weather, traffic, no need to dress up, prepare, or drive to a merchant's place of business, etc.

From the merchant's point of view, electronic commerce offers the advantages of around-the-clock sales, ability to reach people who are shut in or who cannot or do not wish to visit traditional places of business, savings on showrooms and staff, etc.

Because of the increasing amount of merchants on the Internet, customers find that it is more and more possible to shop around to compare and find the best price or best deal. One drawback to electronic commerce, therefore, is that if a customer can easily and quickly find you, the customer can also find a competitor. As in traditional commerce, creating and maintaining repeat business (i.e., loyal customers) is an essential part of success. Customers who return are sought after and valued.

There remains a need in the art, therefore, for improvements in electronic commerce to provide visitors to an electronic commerce site with a motivation for returning to the merchant's website for repeat business, or in other words to develop “e-commerce” or “web” loyalty.

### SUMMARY OF THE INVENTION

An electronic commerce apparatus for offering a promotional award to a visitor to an electronic commerce site is provided according to a first aspect of the invention. The electronic commerce apparatus comprises a connection to a distributed communication network, at least one promotional awards storage area for a visitor including a customer identifier storage and an award amount storage, and an awards rule storage, wherein the visitor is granted a promotional award upon visiting the electronic commerce site, with the promotional award amount being controlled by an awards rule contained in the awards rule storage.

A method for offering a promotional award to a visitor of an electronic commerce site is provided according to a second aspect of the invention. The method comprises the steps of detecting a site visit by a visitor, granting a promotional award to the visitor, and adding the promotional award to a pre-existing promotional award if the site visit is not a first site visit by the visitor, wherein the visitor is motivated to make multiple site visits and a purchase as a result of the promotional award.

A method for offering a promotional award to a visitor of an electronic commerce site is provided according to a third aspect of the invention. The method comprises the steps of detecting a site visit by a visitor, determining whether the visitor has already exceeded a predetermined promotional award limit, granting a promotional award to the visitor if the visitor has not exceeded the predetermined promotional award limit, and adding the promotional award to a pre-existing promotional award if the site visit is not a first site visit by the visitor, wherein the visitor is motivated to make multiple site visits and a purchase as a result of the promotional award.

The above and other features and advantages of the present invention will be further understood from the following description of the preferred embodiment thereof, taken in conjunction with the accompanying drawings.

### BRIEF DESCRIPTION OF THE DRAWINGS

FIG. 1 shows a block diagram of an electronic commerce apparatus for offering a promotional award to a visitor of an electronic commerce site;

FIG. 2 shows a flowchart of a first embodiment of a method of the present invention;

FIG. 3 shows a flowchart of a second embodiment of the method of the present invention;

FIG. 4 shows a screenshot of a first embodiment of a typical visitor computer screen when encountering the promotional award of the present invention; and

FIG. 5 shows a screenshot of a second embodiment of a typical visitor computer screen when encountering the promotional award of the present invention.

### DETAILED DESCRIPTION OF THE PREFERRED EMBODIMENTS

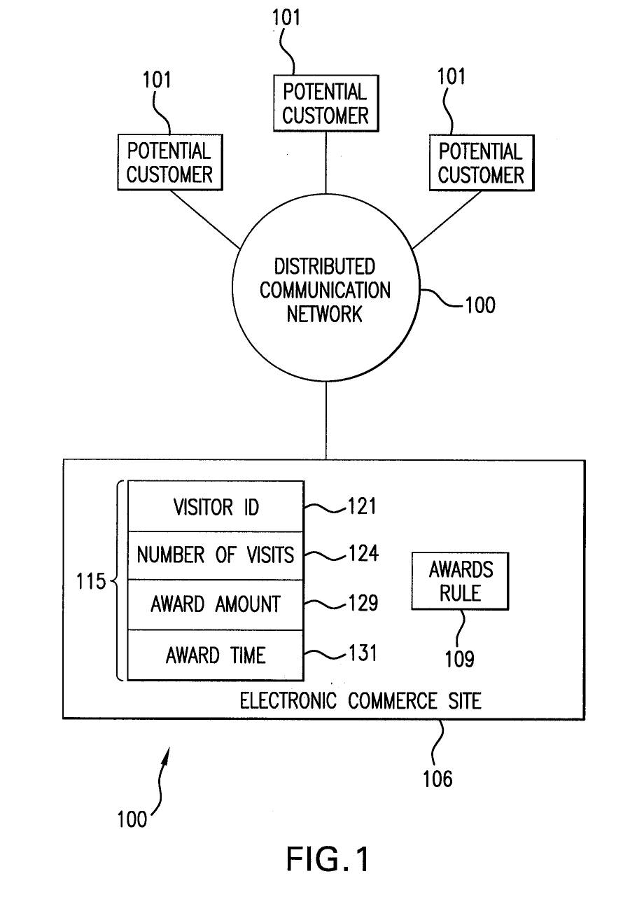

FIG. 1 shows a block diagram of an electronic commerce apparatus 100 for offering a promotional award to a visitor of an electronic commerce site 106. In the figure, an electronic commerce site 106 is connected to a distributed communication network 100, which may be further connected to one or more potential customers 101. According to a preferred embodiment of the invention, the distribution communication network comprises the Internet; however, any type of distributed communication network may be used in conjunction with the principles of the invention. For purposes of explanation only, the invention will be hereinafter described in the context of the Internet and the World Wide Web.

Through the Internet 100, potential customers 101 may visit the electronic commerce site 106 and discover the goods and services offered therein. It is of course desirable that a potential customer 101 visit the electronic commerce site 106 more than once. Repeated visits mean that a potential customer 101 is at least somewhat interested in the offered goods and services. Repeated visits may lead to increased knowledge and familiarity with the goods and services and therefore may lead to a purchase. The bottom line is that the operator of the electronic commerce site 106 wants potential customers 101 to pay repeat visits in order to increase the probability that a potential customer 101 (a visitor) becomes an actual customer.

In order to encourage repeat visits by potential customers 101, the electronic commerce site 106 of the present invention contains several advantageous features. These include an awards rule storage 109 and at least one promotional awards storage area 115. Each potential customer 101 who visits the electronic commerce site 106 may cause an associated promotional awards storage area 115 to be created within the electronic commerce site 106. The promotional awards storage areas 115 thus created may track multiple visitors and track all promotional award activity at the electronic commerce site 106.

The promotional awards storage area 115 may include (for each visitor), a visitor identifier storage 121, a number of previous visits storage 124, an award amount storage 129, and an award time storage 131.

The awards rule storage 109 may contain an awards rule governing promotional awards given by the electronic commerce site 106. The awards rule may set factors such as, for example, a promotional award amount, a size of each successive award including whether the award is incremental, whether a visitor has previously made a purchase, and a time since a previous award.

The promotional award amount is the amount of value awarded to. a visitor. For example, a visitor may be given a promotional award amount of $5 on a first visit, $10 on a subsequent visit, etc. It is preferred that the promotional award amount increase with each visit, so that a visitor is encouraged to try to take advantage of the merchant in order to get the best deal. Another preferred feature is that the promotional award be incremental, increasing regularly with each visit by a particular visitor. However, it should be understood that the promotional award may be decreasing, may be a fixed amount, or may be set in any desired manner.

The awards rule may stipulate that only persons who have not previously purchased are eligible for a promotional award. Therefore, the present invention is aimed at motivating repeat visits by potential customers. Of course, a merchant may allow a promotional award to be given to any and all visitors, but giving a promotional award only to potential purchasers operates under the theory that repeated visits are more likely to lead to a purchase.

The time since a last award portion of the awards rule may be used to control a frequency of visits by a site visitor. The electronic commerce site 106 may use this portion of the rule to prevent a visitor from racking up a maximum promotional award amount by repeatedly visiting the electronic commerce site 106 during a single session. For example, the awards rule may be set so that a visitor may only be able to receive a promotional award once a day. However, the time since last award portion of the awards rule may be set as desired.

The promotional awards storage area 115 includes information for each visitor. This information is needed by the electronic commerce site 106 to implement the awards rule. The visitor identifier storage 121 contains a unique identifier, assigned to each visitor upon their first visit. This identifier may be retained by each visitor by a so-called [symbol] cookie [symbol] stored on the user's computer. Through the use of the visitor identifier, the electronic commerce site 106 may identify and record all subsequent visits of the associated potential customer.

The number of visits storage 124 records the number of all previous visits by the associated potential customer.

The award amount storage 129 is a cumulative total of all promotional award amounts given to the associated potential customer.

The award time storage 131 may store a time of or a time since a last promotional award to the particular visitor. Alternatively, the award time storage 131 may store times of all previous visits.

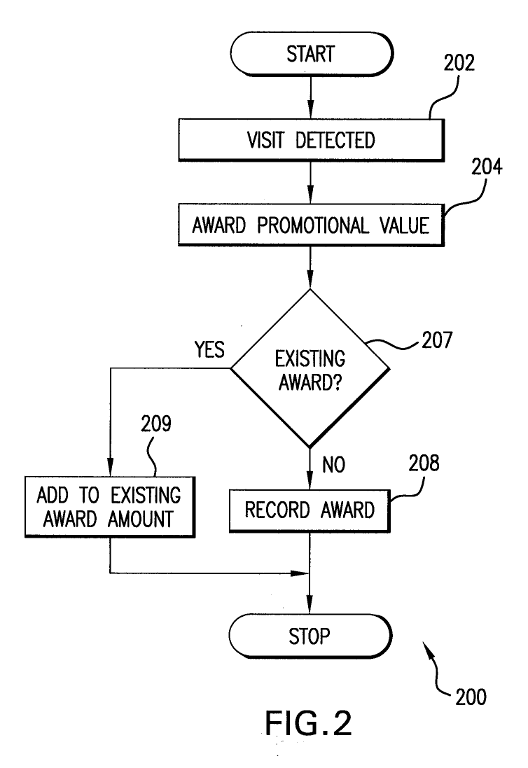

FIG. 2 shows a flowchart 200 of a first embodiment of a method of the present invention. In step 202, a site visit is detected, by detecting the URL or other identifying information as is transmitted to the site in a request sent by a user over the distributed communication network for site page retrieval.

In step 204, a promotional award is given to the visitor. This promotional award is preferably a monetary credit toward a future purchase, but alternatively may be a free product sample or a free service increment (such as a free first hour of a service, for example).

In step 207, it is determined whether the visitor has a pre-existing promotional award amount, by checking the information in the awards storage area 115. If yes, in step 209 the current promotional award is added to the pre-existing amount to form a cumulative total. Alternatively, in step 208 (a first time award), the promotional award is recorded along with the identification information of the visitor. A promotional award thus given and recorded may be credited to a future purchase by the visitor. The promotional award may be used immediately or at a later time, and may be used at the visitor's discretion.

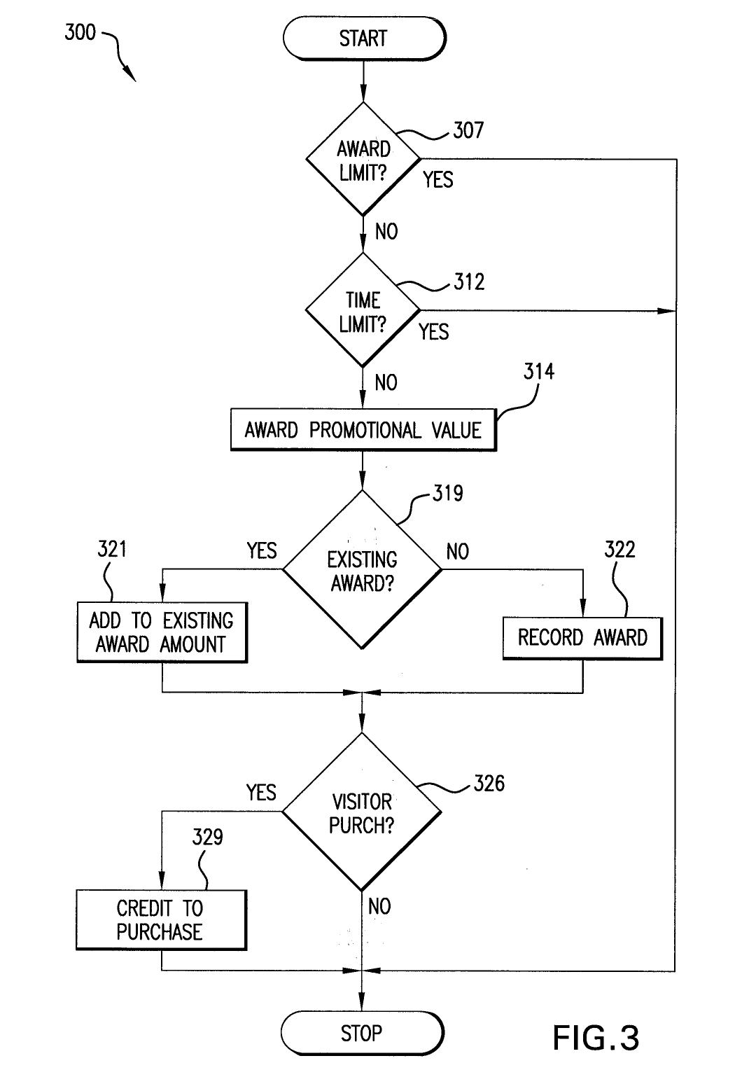

FIG. 3 shows a flowchart 300 of a second embodiment of the method of the present invention. As a preliminary step, a site visit is detected (not shown). In step 307, a predetermined promotional award limit is compared against the promotional award amount stored in the award amount storage 129 (assuming one exists). If the visitor has reached or exceeded the predetermined promotional award limit, the process terminates and no promotional award is given. Else, the method proceeds to step 312.

In step 312, the award time (as may be stored in the award time storage 131) may be compared to a predetermined time limit. If the time since a last promotional award to the visitor is less than the predetermined time limit, then the process terminates. Else, the method proceeds to step 314.

In step 314, a promotional award is given to the visitor, and is communicated to the visitor such as by displaying the award on the visitor's display screen.

In step 319, it is determined whether the visitor has a pre-existing promotional award amount. If yes, the method branches to step 321 and the current promotional award is added to the pre-existing promotional award amount to form a cumulative total. Else, the method branches to step 322 where the promotional award is recorded.

In step 326, it is determined whether the visitor is making a purchase. If the visitor is not purchasing, the process terminates. Else, in step 329, the promotional award may be credited to a purchase.

As a final step, the method may, after a purchase, record the fact that the visitor is no longer eligible for a promotional award (not shown).

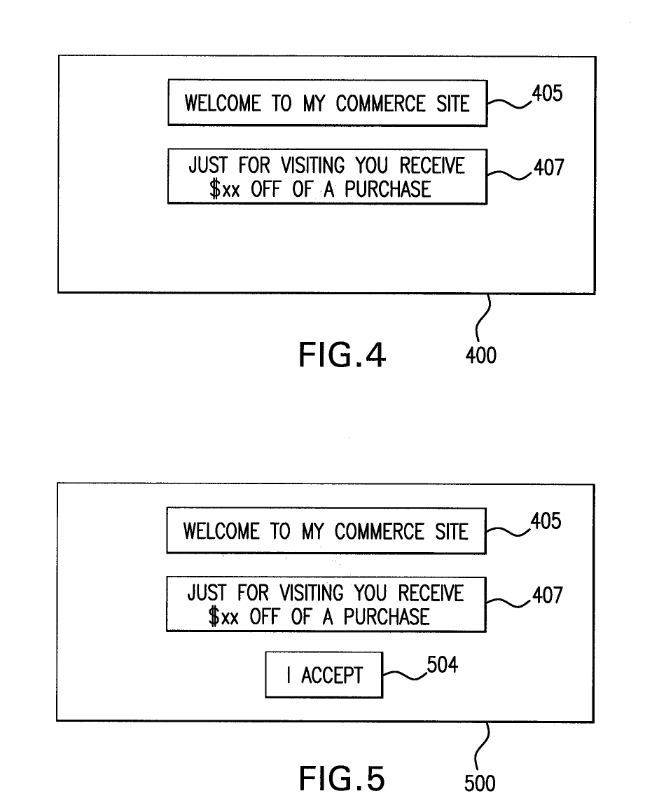

FIG. 4 shows a screenshot 400 of a first embodiment of a typical visitor computer screen when encountering the promotional award of the present invention. The screenshot 400 may include an electronic commerce site identifier banner 405 and a promotional award banner 407. The electronic commerce site identifier banner 405 may identify the particular electronic commerce site 106 and may give additional information such as merchant information and a range of offered goods and services. The promotional award banner 407 may inform the visitor of a promotional award he or she is about to receive or has received.

FIG. 5 shows a screenshot 500 of a second embodiment of a typical visitor computer screen when encountering the promotional award. The screenshot 500 is similar to the screenshot 400 but additionally contains an acceptance button 504. The promotional award may therefore be presented as an offer which the visitor can accept by merely clicking on the acceptance button 504. This presents an advantage in that the visitor may be induced to read the promotional award banner 407, and is less likely to pass by the screenshot 500 without realizing that a promotional award has been given. The visitor therefore is given a greater opportunity to understand the value of the promotional award and is further motivated to return.

While the invention has been described in detail above, the invention is not intended to be limited to the specific embodiments as described. It is evident that those skilled in the art may now make numerous uses and modifications of and departures from the specific embodiments described herein without departing from the inventive concepts.

1. An electronic commerce apparatus for offering a promotional award to a visitor of an electronic commerce site, comprising:
a connection to a distributed communication network;
a promotional awards storage area, including:
a visitor identifier storage that contains unique identification information for each visitor to said site,
a number of previous visits storage that contains information pertaining to prior visits to said site by visitors identified in said visitor identifier storage, and
an award time storage that stores a time of a last award for each visitor to said site; and
an awards rule storage that stores rules for crediting awards to visitors of said site according to information stored in said visitor parameter storage, said award rule storage including a rule that determines a specific promotional award based on whether a predetermined time period has elapsed since said last award time;
wherein a visitor of said site is granted a promotional award by retrieving visitor parameter information from said visitor parameter storage corresponding to customer identification information stored in said customer identifier storage in response to visitor identification information provided to said apparatus upon visitor access to said site, and applying retrieved visitor parameter information to award crediting rules retrieved from said awards rule storage.

2. The electronic commerce apparatus of claim 1, wherein said visitor parameter storage includes a number of previous visits storage that stores a number corresponding to the total number of visits to said site by a particular visitor, and wherein said awards rule storage stores an awards rule that determines a specific promotional award based on a number of previous visits to said site by a visitor as stored in said number of previous visits storage.

3. (canceled)

4. The electronic commerce apparatus of claim 1, wherein said promotional awards storage area includes an award amount storage that stores a cumulative total value of awards credited to a particular visitor, and wherein said awards rule storage stores an awards rule that determines a specific promotional award based on the cumulative total award value stored in said award amount storage.

5. The electronic commerce apparatus of claim 4, wherein said award amount rule contains a predetermined promotional award limit.

6. The electronic commerce apparatus of claim 5, wherein said award amount limit is reset to zero and said visitor is no loner eligible for said promotional award after said visitor makes a purchase from said site.

7. The electronic commerce apparatus of claim 1, wherein said promotional award according to said awards rule increases with successive visits by said visitor.

8. The electronic commerce apparatus of claim 1, wherein said promotional award is credited to a purchase price of a purchase by said customer.

9. The electronic commerce apparatus of claim 1, wherein said apparatus is connected through said connection to the Internet.

10. A method for offering a promotional award to a visitor to an electronic commerce site, comprising the steps of:
detecting a site visit by a visitor and tracking a number of visits to said site by said visitor;
granting a promotional award for each site visit by said visitor, said promotional award having a value that increases for each successive site visit by said visitor; and
adding said promotional award values together to form a cumulative total for said visitor.

11. The method of claim 10, wherein said promotional award decreases, rather than increases, with each site visit by said visitor.

12. The method of claim 10, wherein said promotional award increases incrementally with each site visit by said visitor.

13. (canceled)

14. The method of claim 10, wherein said promotional award is granted only to first-time purchasers.

15. The method of claim 10, wherein said promotional award is granted to said visitor if said visitor has not exceeded a predetermined promotional award limit.

16. The method of claim 10, wherein said promotional award is credited to a purchase price of a purchase by said visitor.

17. The method of claim 10, wherein said visitor must affirmatively select the promotional award.

18. The method of claim 10, wherein said electronic commerce site is accessed via the Internet.

19. A method for offering a promotional award to a visitor of an electronic commerce site, comprising the steps of:
detecting a site visit by a visitor;
storing information identifying a visitor and identifying prior promotional awards credited to said visitor:
determining whether said visitor has already exceeded a predetermined promotional award limit;
granting a promotional award to said visitor if said visitor has not exceeded said predetermined promotional award limit, said promotional award having a value that is greater than the value of the preceding promotional award granted to said visitor for visiting said site; and
adding said promotional award value to the value of said prior credited promotional awards associated with said visitor identification information.

20. The method of claim 19, wherein an amount of said promotional award decreases, rather than increases, with each site visit by said visitor.

21. The method of claim 19, wherein an amount of said promotional award increases incrementally with each site visit by said visitor.

22. The method of claim 19, wherein said promotional award is granted only to first-time purchasers.

23. The method of claim 19, wherein said visitor must affirmatively select the promotional award.

24. The method of claim 19, wherein said promotional award is credited to a purchase price if said visitor makes a purchase.

25. The method of claim 19, wherein said electronic commerce site is accessed via the Internet.

26. The electronic commerce apparatus of claim 4, wherein said award time storage stores the times of all previous site visits by said visitor.

27. The method of claim 10, wherein only visitors who have not previously purchased from the site are eligible for said promotional award.

28. The method of claim 19, wherein only visitors who have not previously purchased from the site are eligible for said promotional award.
